(19) United States
(12) Patent Application Publication
(10) Pub. No.: US 2025/0260575 A1
(43) Pub. Date: Aug. 14, 2025

(54) Method and Apparatus for Automatic Review of Video Security Patrols

(71) Applicant: Immix Software LLC, Charlotte, NC (US)

(72) Inventors: Mark William Kenna, Sketty (GB); Kevin Robert Lippiatt, Swansea (GB)

(73) Assignee: Immix Software LLC, Charlotte, NC (US)

(21) Appl. No.: 19/046,910

(22) Filed: Feb. 6, 2025

Related U.S. Application Data
(60) Provisional application No. 63/552,173, filed on Feb. 11, 2024.

(51) Int. Cl. H04L 9/32; H04L 9/08; H04L 9/40

(52) U.S. Cl. CPC H04L 9/3213; H04L 9/0891; H04L 63/10

(57) ABSTRACT

A method for the secure scheduled review of video security feeds on a secure server by an outside vendor intermediated by a security platform, AutoPatrol Cloud Platform. The secure server has one or more tenants which communicate with one or more security devices providing video security feeds. The Platform communicates with the tenant via a tenant API and a data API. The Platform verifies the vendor by a security measure and processes requests made by the vender through a vendor API. Vendor requests are checked against a patrol schedule generated by the security customer and, if the request conforms to the scheduled, prompts the Tenant to generate a short-lived authentication token and URL, which is then passed to the Platform and on the vendor. The vendor may access the security feed for processing according to the schedule. Vendor alerts and post processing are intermediated by the Platform.

### CROSS-REFERENCE TO RELATED APPLICATION

This application is a nonprovisional patent application of and claims the benefit of U.S. Provisional Patent Application No. 63/552,173, filed Feb. 11, 2024 titled “Method and Apparatus for Automatic Review of Video Security Patrols,” the disclosure of which is hereby incorporated herein by reference in its entirety.

### TECHNICAL FIELD

The present disclosure relates to the secure review of video security footage. More specifically, the present disclosure is directed to a method of secure scheduled review of video security feeds on a secure server by a remote vendor by means of a security platform using a vendor API, a Tenant API, and a data API.

### BACKGROUND

This disclosed invention is in the security field generally and specifically relates to the control of security footage as it relates to review and processing by third party vendors.

Security footage is an important part of physical security for commercial, infrastructural and government applications. Real time security footage allows security personnel to review potential security incidents much faster than traditional patrols. Stored security footage allows for deeper analysis than traditional patrol logs. However, the processing of security footage has long been a concern. It is easy for an organization to generate more security footage then can be timely reviewed by their security staff.

A number of vendors exist to remotely monitor security footage. Many of these vendors use computer vision and machine learning to process, classify, and glean additional security information from security footage. Many in the security industry have a preference to store security footage within a premises that is subject to physical security (e.g. “on-prem” servers). Security footage is both sensitive and may be subject to retention rules and regulations. Video files are notoriously bulky and can quickly fill up electronic storage media. There are known issues with allowing remote vendors access to access and process security footage.

What is needed is a secure method to allow a third-party vendor to obtain timely, secure, limited access to Security footage in a predictable and scheduled manner.

### SUMMARY

The present invention is a solution to the above-mentioned problems.

While a traditional patrol allows one or more security officers walks or drives along a predetermined route at predetermined times to observe and report any security information or incidences encountered on the route, a patrol of security footage allows the security officer to review predetermined security feeds (e.g. specific cameras) at predetermined times to observe and report any security information or incidence. The present invention allows such a patrol of security footage to occur automatically by facilitating specific files located at a secure location, such as an on-prem server, to be accessed through a cloud-based AutoPatrol Cloud Platform consisting of two or more APIs, an orchestration service, and an administrative module by a third party trusted to access a limited set of patrol related files. Wherein the AutoPatrol Cloud Platform maintains a schedule of video patrols requested by the customer via a first API so that a Vendor facilitate an automatic patrol by requesting relevant and authorized security footage via a second API. This schedule is prepopulated according to the needs of the customer, such as a security client. Whereas the secure location has an instance of a video security interface tenant, such as Immix, and includes a database of stored and live video footage.

When a customer prepopulates a patrol to take place, that schedule is then shared with the orchestration system, the administrative module and, via the second API, one or more vendors. During the time set by the Customer, the administrative module allows a properly authenticated vendor to requests security footage through the second API. This request will, in turn, trigger a request from the AutoPatrol Cloud Platform to the on-prem server. The orchestration system keeps track of time and confirms that the vendor does, in fact, request the scheduled video footage at the scheduled time. In the event that the orchestration system detects that the vendor has not made a timely request as per the schedule the orchestration system will alert the customer that a manual review may be necessary. Once the request for footage has been received by the AutoPatrol Cloud Platform it is passed on to the Vendor for analysis. Here again, the orchestration system has an expected response time for each type of Vendor and each analytic activity. The orchestration system will check to see if the vendor responds within the expected response time to the second API for each video request the vendor makes. In the event that the Vendor exceeds this expected response time the orchestration system will notify the customer that the vendor has timed out and that a manual review may be needed.

In normal operation, wherein the Vendor responds to each item of requested footage with its analysis; the Customer will receive a notification with the analysis provided by the Vendor. In an example, Customer may receive an alert showing potential intruders or vandalism is connection with the appropriate security footage. In another example, Customer may receive an alert showing unauthorized vehicles in a parking lot in connection with the appropriate footage.

### BRIEF DESCRIPTION OF THE DRAWINGS

For a more complete understanding of the present invention and the advantages thereof,

reference is now made to the following descriptions taken in conjunction with the accompanying drawings, in which:

FIG. 1 shows the invention in a flow diagram.

FIG. 2A shows the authentication requests from Tenant to Cloud.

FIG. 2B shows the authentication requests from Vendor to Cloud.

FIG. 2C shows authentication process from Cloud to Tenant.

FIG. 2D shows requests for data stream.

FIG. 3A shows a typical series of data requests in structural view.

FIG. 3B shows a typical series of data requests in temporal view.

### DETAILED DESCRIPTION

The present invention is directed to a method for the secure processing of previously selected security footage data, or a security feed, at prescheduled times by authorized third-parties through the intermediation of a cloud-based AutoPatrol Cloud Platform which allows limited third-party access to the security footage which, itself, is located at a secure server.

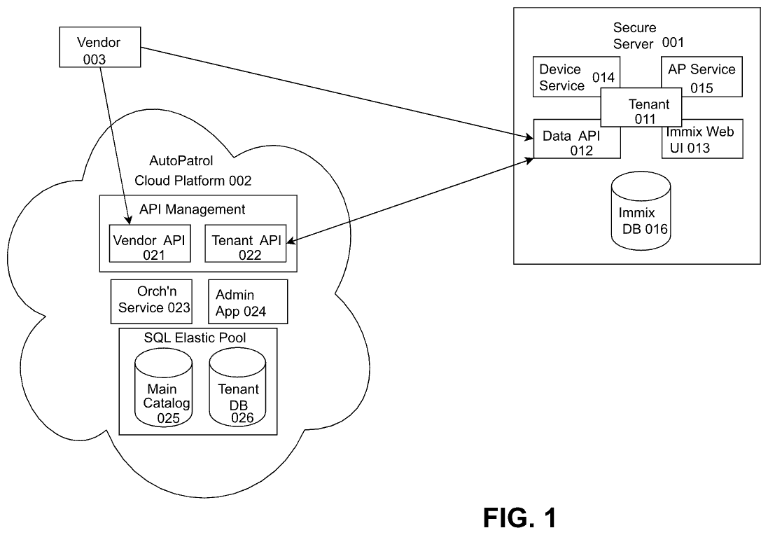

FIG. 1 shows an embodiment of the invention to further illustrate the various modules incorporated. In this example the invention includes a secure server 001 which here is shown as an Immix On-Premise server, an AutoPatrol Cloud Platform 002 which resides in the cloud; both of which are communicatively connected to a Vendor 003. The secure server does not need to be located on secured premises but should be subject to security rules which limit third party access. The secure server may, in fact, be a plurality of secure servers. While data flows to and from the Vendor will be described herein, the inner workings of the Vendor will vary and are not relevant to the invention. The functions provided by the Vendor are commercially available using a variety of existing technologies. The preferred embodiment of the invention anticipates the Vendor it will grant limited access to, will to be an Ai Processor which will run detection and/or classification analysis on the security footage.

As shown in FIG. 1, the secure server 001 comprises an installation of Immix On-Premise software which is installed either physically or virtually; for the purpose of this application the On-Premise Installation of Immix is referred to as a tenant 011. The tenant comprises a data API 012 and a web interface 013 both of which communicatively connect said tenant to the AutoPatrol Cloud Platform 002. The data API functions primarily a means of communicating machine-to-machine communications. The web interface, typically a closed intranet, is the primary user-interface for the Immix On-Premise software and allows for, among a variety of other security functions, the creation of video patrol events.

The tenant 011 further comprises a device service 014 which acts as a proxy or broker between a plurality of physical security devices (for the purpose of this application all of these security devices will be IP cameras or devices capable of capturing video feeds). The device service relays security data, such as security footage, in an agnostic manner that abstracts away the different formatting quicks of individual security devices and provides the security footage in a generally accusable format. Used in this specification the term tenant refers to the entire block shown in FIG. 1 and includes software and hardware components as well as customer input in the form of video patrol schedules which are the generated by customers and are the subject of communication between the tenant and the AutoPatrol Cloud Platform.

The tenant 011 further comprises an AutoPatrol Service 015, a background software service that is installed on the secure server 001, which serves as a housekeeping service to manage and maintain files stored within the filestore.

The Secure Server 001 comprises a local database 016 in which the Tenant 011 stores all data for the Immix on premise solution. In the preferred embodiment recordings of security footage are kept in a plurality of hard disks which act as a file store (not shown).

As shown in FIG. 1, the secure server 001 is communicatively connected to the AutoPatrol Cloud Platform 002 via the data API 012 and, in this embodiment, indirectly through the web interface 013.

A Customer may use the web interface 013 to set a schedule of video patrols. The definitive version of the schedule of video patrols resides within the AutoPatrol Cloud Platform in the appropriate tenant database. In the preferred embodiment, video patrol schedules are saved in the form of a designated site and a corresponding cron expression. Used herein, a ‘cron expression’ refers to a precisely timed, indefinitely repeating event as defined within a daily, weekly, monthly or annual basis (e.g. every Monday at 14:00 UTC). The use of a cron expression is optional and video patrols may be set at finite dates and times. Used herein, a ‘site’ refers to a collection of physical security devices, as abstracted through the devices service module, which are organized by the physical location being monitored by said collection of physical security devices.

Alternatively, the schedule of video patrols may be saved in any manner that indicates a precise time and camera feed identity associated with the desired patrols.

Video patrol schedules may overlap with one another and multiple camera feeds may be used simultaneously by multiple different patrols. This is because the tasks associated with video patrols are asynchronous and not resource limiting. It is possible for multiple video patrols to be set which use overlapping camera feeds at overlapping times; this may be done to create a secure redundancy or to allow a selection of video footage to be analyzed by multiple different people, systems, or algorithms simultaneously.

FIG. 1 shows the AutoPatrol Cloud Platform 002 comprising two or more APIs (shown here to include a Vendor API 021 and a Tenant API 022), an orchestration service 023 and an administrative application 024. The AutoPatrol Cloud Platform 002 comprises a system clock synchronized to UTC. The AutoPatrol Cloud Platform includes a plurality of resources for each tenant that is connected such as a catalog 025 and a tenant database 026. In normal operation AutoPatrol Cloud Platform may support a plurality of tenants. A new entry to the catalog 025 and a tenant database 026 will be added for each new tenant is that will be supported by the AutoPatrol Cloud Platform; these resources will exist on different hardware than the secure server.

The orchestration service is a background service that is a component of the AutoPatrol Cloud Platform. It serves to oversee that the processing of scheduled patrols is occurring and takes action otherwise. It also has other background tasks to maintain. The Administrative application is a software user interface that is a component of the AutoPatrol

Cloud Platform which provides access for Immix Protect staff to interact with the administrative functions of the AutoPatrol Cloud Platform.

The AutoPatrol Cloud Platform maintains a number of APIs for communication between the AutoPatrol Cloud Platform 002 and its plurality of vendors and the tenants. The embodiment shown in FIG. 1 show two APIs, the Vendor API 021 and the Tenant API 022, but other APIs may be added to these interfaces to enable different types of communication between different Vendors and/or Tenants. The exact nature of authentication and dataflows will be explained below but it is worth noting that the authentication described is for the preferred embodiment. Methods of authentication are a well-established art and may well understood methods can be used without any major change to the invention. As example, the authentication methods described could be replaced with any form of basic authentication, digest authentication, bearer token authentication or OAuth/OIDC authentication without major affecting core function of the invention.

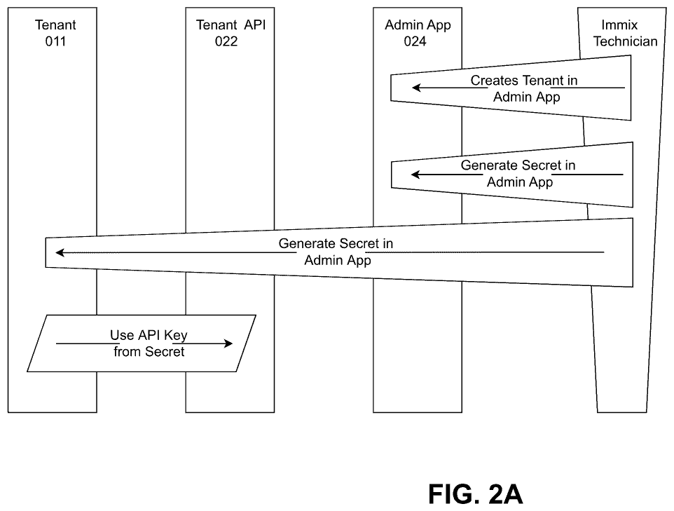

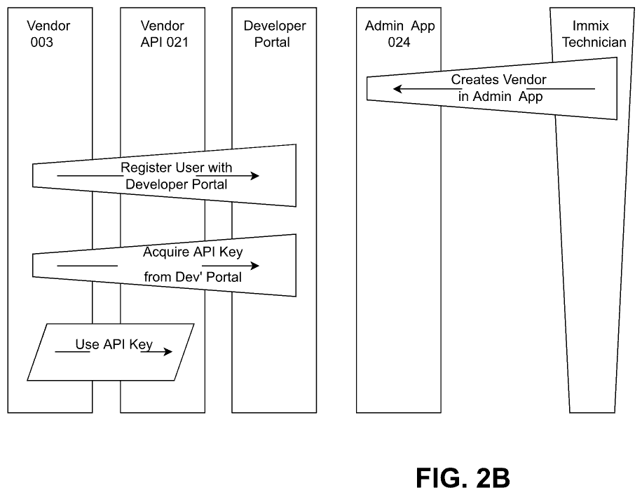

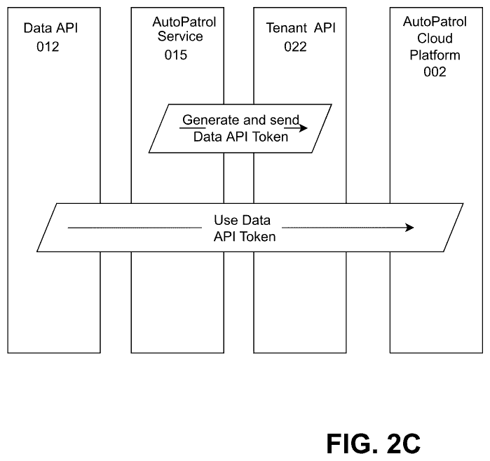

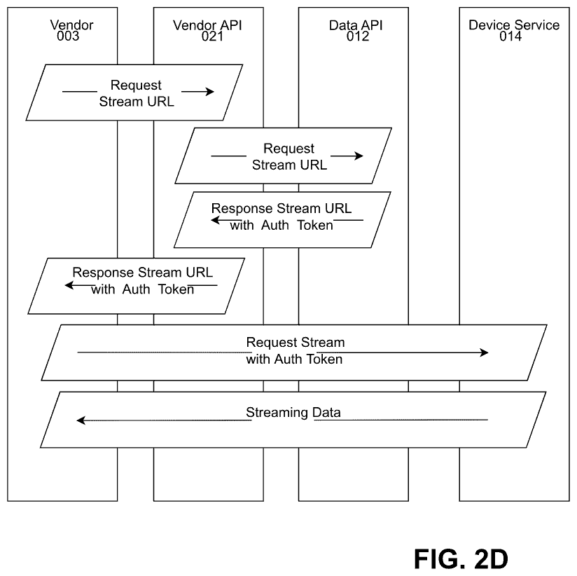

As shown in FIG. 2A, the tenant may communicate with the AutoPatrol Cloud Platform through the tenant API 022. For each of the plurality of tenants, the tenant API Key is generated in an administrative portal by an Immix staff member which is shown to create the tenant in the Admin App 024. This administrative portal is part of the Admin Application 024 which functions as a software user interface that is a component of the AutoPatrol Cloud Platform 002. The Admin App provides access for Immix Project staff to interact with the administrative functions of the AutoPatrol Cloud Platform. The API key is then included along with other details in a JSON object (called a secret), which can be inserted into the secure server 001, such as an on-premise database, in an encrypted secret store (secret prefs). The secure server 001 will then include the API key as a header in the HTTP requests to the Tenant API 022. This enables the AutoPatrol Cloud Platform to identify the tenant 011.

As shown in FIG. 2B, the Vendor API is responsible for authentication and approval of requests made by vendors to access on prem, schedule and patrol data. Each authorized vendor will receive a unique API key to access the Vendor API 021 which is generated by an API Management service. The Vendor API will allow the vendor to access the video patrol schedules which have selected the vendor to process security footage. The vendor may use this API to submit surveillance footage access requests in accordance to this schedule. In the preferred embodiment a vendor's request for access will be made by submitting a timely request to access the site as defined in the video patrol schedule; however alternative request types, such as a request that specifies the footage requested on the device level are also anticipated. The AutoPatrol Cloud Platform will check the video patrol schedules stored in the appropriate tenant database 026 to confirm that the vendor's request matches the scheduled patrol both in terms of the time in which the request is made and the camera feeds that the vendor is requesting to access. If the time, video feed, and the vendor identification all match the scheduled video patrol stored in the tenant's database 026, then AutoPatrol Cloud Platform will begin the following process to provide the Vendor with a single use URL to allow the Vendor to make requests to the tenant's device service 014 on the secured server 001.

Alternatively, if said tenant database 026 includes a scheduled video patrol but the vendor fails to the security footage from the requested device service 014 at the requested time, then the orchestration service 023 will take action. The orchestration service 023 monitors the timeclock and compares the vendor requests authorized by the video patrols scheduled on the plurality of tenant database 026 to the vendor request actually made to the AutoPatrol Cloud Platform 002; in the event that a scheduled request from the vendor to the AutoPatrol Cloud Platform is not made by a time, as according to the timeclock, compatible with the scheduled video patrol then the orchestration service will initiate a communication to the tenant notifying the customer that scheduled vendor hasn't performed a patrol.

FIG. 2C shows communication between the AutoPatrol Cloud Platform 002 and the secure server 001. To generate the authentication token used to send requests back to the on secure server 001, an encrypted secret is retrieved from the tenant 011 itself, which is then decrypted to extract a salt stored within. That salt is then applied to the encrypted secret, and then the combined secret plus salt are encrypted again to give the end result which is then transmitted securely to the AutoPatrol Cloud Platform 002.

As a further security measure, during the initial configuration of the on prem tenant, Immix staff creates a text value along with the hash value. This is then encrypted and saved for future use. The text value contains the details (url, secret) needed to communicate with the AutoPatrol Cloud Platform. This text value is then used and combined with the generated hashed and is encrypted and saved in the Cloud Platform for future use. Every request to the on prem data API from the Cloud Platform is required to have a header in the request this token which is then used to validate the request. The text value serves as an additional security measure containing data that acts as an additional security check.

FIG. 2D shows how vendors request data through the AutoPatrol Cloud Platform. The tenant database 026 within the AutoPatrol Cloud Platform 002 maintains the authoritative schedule of video patrols specified by tenants; these video patrol schedules are stored within in tenant specific databases shown in the diagram 026. The main catalog database 025 stores information about tenants, vendors, contract information and system logs. The vendor initiates the request to obtain security footage from the secure server 001. When a properly authenticated vendor calls into the AutoPatrol Cloud Platform, the cloud platform passes on a mirror request to stream the security footage to the secure server's data API 012. The secure server responds by generating a unique URL which contains a short-lived authentication token which is also generated upon request. The lifespan of the authentication token may vary depending on vendor specification and client needs, but in the preferred embodiment this token will last no more than sixty seconds. This response is sent to the cloud platform via the Data API 012 which passes the URL and token to the Vendor via the Vendor API 022. The URL and token allow the Vendor access to a live feed of the relevant security footage on the device service level.

In the preferred embodiment certain Vendors, such as AI computer vision detection and classification services, will not have access to any footage stored within the secure server's file stores but may only request security footage from life feeds accessible directly from the device service 014. While certain types of analysis may require historic security footage, the majority of real-time security applications require only the processing of direct camera feeds. This embodiment has the advantage of drastically limiting the vendor's access to on prem data.

After the vendor has processed the requested security footage the vendor will respond with post processing information to the AutoPatrol Cloud Platform which, in turn, will message the operator in accordance with Immix messaging policy; at the current time it is Immix policy only to pass on Alert data to avoid operator overload. The AutoPatrol Cloud Platform store datalogs about the vendor's activities which may be requested by the customer/tenant be provided with a patrol highlight showing all actions taken by the vendor. The security footage may also be augmented with post processing information, such as bounding boxes or descriptions. All security footage will be saved to the secure server's filestore and retained in accordance with law and retention policy.

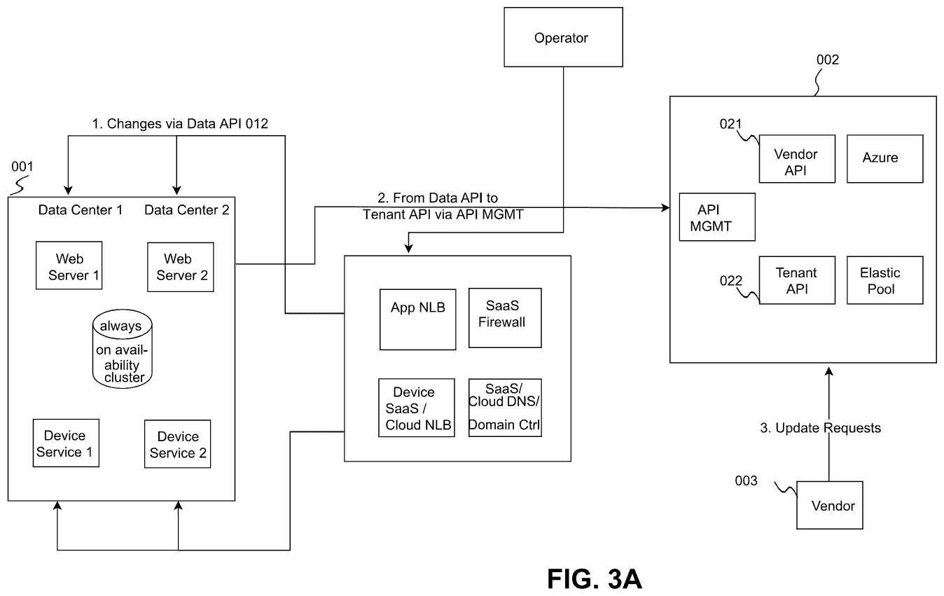

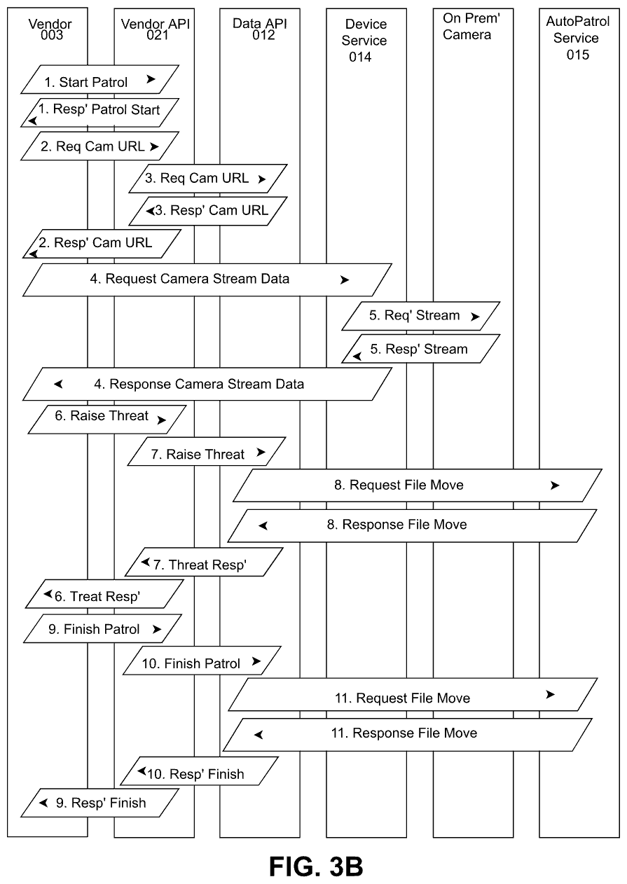

FIG. 3A and FIG. 3B shows the dataflow for a typical vendor aided detection on a live-stream security feed in more detail.

FIG. 3B shows the vendor initiate an exchange using the vendor's unique API key to access the Vendor API 021 which makes a request to the AutoPatrol Cloud Platform 002. The Vendor's API key is validated against the AutoPatrol's Cloud Platform's subscription manager and the Vendor's API key will indicate which sites, or individual video feeds, that the Vender has permission to access. FIG. 3A shows an example of this communication as an update request between the Vendor and the AutoPatrol Cloud Platform 002 via the Vendor API 021.

The Vendor then requests security footage. FIG. 3B shows the vendor request security footage; in the form of a Camera Stream Data. In the preferred embodiment this is accomplished by having the device server, which abstracts from a plurality of live camera feed, to share the relevant feeds via a streaming URL. The AutoPatrol Cloud Platform 002 checks the time in UTC, via system time, and the tenant database to ensure that the live-camera requested is identified in a scheduled patrol for the specific vendor at the time requested. FIG. 3A shows the relationship between the AutoPatrol Cloud Platform and Secure Sever 001 communicating by means of the Data API 012.

Once confirmed, the AutoPatrol Cloud Platform 002 sends a request for the specified streaming URL to the secure server 001 via the data API 012. Upon the request the secure server generates a unique URL which contains a short-lived authentication token which is returned to the AutoPatrol Cloud Platform via the data API 012. During the generation of the token, it is signed and encrypted using the install keys so only the relevant device server is able to authenticate against it. FIG. 3A shows an example of this communication from the secure server and the AutoPatrol Cloud Platform via the data API. The unique URL and short-lived authentication token are then returned to the Vendor in completion of the Vendor's initializing request.

FIG. 3B shows the Vendor requests access to the live security camera feed using the authentication token. The vendor has a brief time period, typically ten seconds, in which the authentication token is good. If vendor fails to access the live-feed in this time period the vendor will need to send a second access request to the AutoPatrol Cloud Platform. The vendor accesses the data stream provided by the secure server, which itself pulls the live-feed directly from the requested camera.

We claim:

1. A computer implemented method of granting selective access to a security feed on a secure server to a vendor trusted to process said security feed comprising:
generating a video patrol schedule which designates a time and a physical security device;
storing the video patrol schedule on an AutoPatrol Cloud Platform in communicatively connected to the secure server;
restricting access to the AutoPatrol Cloud Platform to the vendor by a security means;
restricting communication to the AutoPatrol Cloud Platform from the vendor to a Vendor API;
restricting communication to the AutoPatrol Cloud Platform from the secure server to a Tenant API;
receiving an authenticated request through the Vendor API; confirming that the authenticated request from the vendor is constant with the video patrol schedule;
forwarding the authenticated request from the AutoPatrol Cloud Platform to the secure server through the data API; and
generating a short-lived authentication token and unique URL to access the security feed; providing the authentication token and unique URL to the vender.

2. The computer implemented method of claim one,
wherein the security feed is provided by means of a device service layer.

3. The computer implemented method of claim one,
wherein the step, generating a video patrol schedule designating a time and a physical security device is accomplished using a web interface.

4. The computer implemented method of claim one,
wherein the video patrol schedule uses a cron expression and a site to designate the time and the physical security device.

5. The computer implemented method of claim one,
wherein the vendor is an Ai Processor trusted to receive limited access to the security feed.

6. The computer implemented method of claim five,
wherein the secured server is accompanied by one or more additional secured server, each said additional server having a Tenant.

7. The computer implemented method of claim six,
wherein, the AutoPatrol Cloud Platform further comprises a plurality of Tenant APIs for each of the plurality of Tenants.

8. The computer implemented method of claim seven,
wherein the plurality of Tenants is each generating a video patrol schedule which designates a time and a physical security device.

9. The computer implemented method of claim eight,
wherein the step related to storing the video patrol schedule on an AutoPatrol Cloud Platform in communicatively connected to the secure server, are stored in a Tenant Database associated with the Tenant involved in generating the video patrol schedule.

10. The computer implemented method of claim one, further comprising the step:
creating a text value comprising communication details along with a hash value which are encrypted together for later use.

11. The computer implemented method of claim one, further comprising the following steps:
generating a second authentication token used to send requests from the AutoPatrol Cloud Platform to the on secure server;
retrieving an encrypted secret said secure server;
decrypting the secret and extracting a salt stored;
applying said salt to the encrypted secret;
re-encrypting a combined secret plus salt are encrypted; and
securely transmitting the end result to the AutoPatrol Cloud Platform.

12. A computer system comprising:
a processor; and
a memory unit having instructions stored thereon, which when executed by the process cause the cause the system to:
generate a video patrol schedule designating a time and a physical security device;
store the video patrol schedule on an AutoPatrol Cloud Platform in communicatively connected to the secure server;
restrict access to the AutoPatrol Cloud Platform to the vendor by a security means;
restrict communication to the AutoPatrol Cloud Platform from the vendor to a Vendor API,
restrict communication to the AutoPatrol Cloud Platform from the secure server to a Tenant API;
receive a authenticated request through the Vendor API; confirm that the authenticated request from the vendor is constant with the video patrol schedule;
forward the authenticated request from the AutoPatrol Cloud Platform to the secure server through the data API;
generate a short-lived authentication token and unique URL to access the security feed; and
provide the authentication token and unique URL to the vender.

13. The computer system of claim twelve,
wherein the security feed is provided by means of a device service layer.

14. The computer system of claim twelve,
wherein the video patrol schedule uses a cron expression and a site to designate the time and the physical security device.

15. The computer system of claim twelve,
wherein the vendor is an Ai Processor trusted to receive limited access to the security feed.

16. The computer system of claim fifteen,
wherein the secured server is accompanied by one or more additional secured server, each said additional server having a Tenant.

17. The computer system of claim twelve,
wherein, the AutoPatrol Cloud Platform further comprises a plurality of Tenant APIs for each of the plurality of Tenants.

18. The computer system of claim seventeen,
wherein the plurality of Tenants is each generating a video patrol schedule which designates a time and a physical security device.

19. The computer system of claim twelve eighteen,
wherein the video patrol schedule is stored in a Tenant Database associated with the Tenant involved in generating the video patrol schedule.
